(19) United States
(12) Patent Application Publication
(10) Pub. No.: US 2008/0007637 A1
(43) Pub. Date: Jan. 10, 2008

(54) Image sensor that provides compressed data based on junction area

(75) Inventor: Andrei Cernasov, Ringwood, NJ (US)

Correspondence Address: Honeywell International, Inc.;Law Department AB2, P.O. Box 2245, Morristown, NJ, 07962-2245, US

(73) Assignee: Honeywell International, Inc.

(21) Appl. No.: 11/482,034

(22) Filed: Jul. 7, 2006

(51) Int. Cl. H04N 9/04

(52) U.S. Cl. 348/278

(57) ABSTRACT

An image sensor is configured to output transformed data. The image sensor includes a set of pixel sensors. Each pixel sensor is divided into sub-divisions having sensitivities based on a transformation algorithm.

### FIELD

This disclosure generally relates to image sensors. More particularly, the subject matter of this disclosure pertains to image sensors that are capable of outputting compressed data in their raw output.

### BACKGROUND

In a digital imaging device, such as a digital camera, light is focused on a digital image sensor. Most digital cameras use either a charge-coupled device (CCD), or complementary metal oxide semiconductor (CMOS) chip, as an image sensor. When a picture is taken, the image sensor samples the light coming through the lens and converts it into electrical signals. Typically, these signals are boosted by an amplifier and sent to an analog-to-digital converter (ADC) that changes those signals into digital data. An onboard processor then processes the digital data to produce the final image data, which may be stored on a memory card or sent as a file.

Most digital imaging devices use 12- or 14-bit ADCs and perform a wide variety of processing on the digital data, such as de-mosaicing, white balance, noise reduction, and the like. This processing can consume a significant amount of power and time to perform.

In addition, almost all conventional devices default to saving images in Joint Photographic Experts Group (JPEG) format, which is a compressed format. As a result, a digital imaging device down samples the original 12- or 14-bit data back down to 8 bits before performing the JPEG compression. In addition, the processor in the digital image device must perform a large set of calculations on the digital data for JPEG compression. Indeed, some digital imaging devices may include a separate digital signal processor or other form of processor in order to perform JPEG compression. Therefore, support of the JPEG algorithm can consume a large amount of time and power in a digital imaging device.

It may be desirable to reduce the amount processing and power required for JPEG images. Due to their popular acceptance, JPEG images can be generated and handled by a wide variety of devices. For example, devices like video cameras, mobile phones, etc., are now capable of providing JPEG images. JPEG images are also basic components of compressed video standards such as Moving Pictures Experts Group (MPEG). However, these devices must also conserve space used by the components and the amount of power they consume (since they run on batteries). It may also be desirable to speed the processing related to JPEG images or MPEG video, such as, for a security camera.

Accordingly, it would be desirable to systems and methods that efficiently implement compression algorithms to produce an image, such as a JPEG image. It may also be desirable to provide systems and methods that can acquire a compressed image, such as a JPEG image, more quickly than conventional technologies.

### SUMMARY

Embodiments of the present teaching are directed to an image sensor configured to output transformed data. The image sensor comprises a set of pixel sensors. Each pixel sensor is divided into sub-divisions having sensitivities based on a transformation algorithm.

Embodiments also are directed an imaging device configured to provide transformed image data. The imaging device comprises a set of sensors divided into sensor blocks. Each sensor is divided into sub-divisions having sensitivities based on a transformation algorithm. The imaging device also comprises a set of measuring circuits coupled to the set of sensors. Each measuring circuit is coupled to corresponding sub-divisions of different sensors in a sensor block.

Embodiments are also directed to a method of providing an image in transformed form. The method comprises gathering data from the set of pixel sensors. Each pixel sensor is divided into sub-divisions having sensitivities based on a transformation algorithm. The method also comprises providing the transformed data as raw output from the sensor array.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the present teaching and together with the description, serve to explain the principles of the invention.

FIG. 1 is a diagram illustrating an exemplary imaging device consistent with embodiments of the present teaching;

FIG. 2 is a diagram illustrating an exemplary image sensor consistent with embodiments of the present teaching;

FIGS. 3 and 4 are diagrams illustrating a sensor array consistent with embodiments of the present teaching;

FIG. 5 is a diagram illustrating a measuring circuit consistent with embodiments of the present teaching; and

FIG. 6 is a diagram illustrating an exemplary process flow consistent with embodiments of the present teaching.

FIG. 7 is a diagram illustrating a portion of a sensor array consistent with the present teaching.

FIG. 8 is a diagram illustrating an exemplary process flow consistent with embodiments of the present teaching.

### DETAILED DESCRIPTION

As noted above, in conventional devices, an image detected by an image sensor is converted into digital form and then uses “back-end” processing to compress the image into a desired format, such as a JPEG image. Unfortunately, this type of “back-end” processing often requires the use of a separate digital signal processor to perform the calculations necessary for the compression algorithm, such as JPEG compression algorithm for still images or MPEG compression algorithm for moving images. This is in turn causes conventional devices to consume a large amount of power, take long times to acquire an image, and increases the size of the device.

However, embodiments of the present teaching provide an image sensor that implements “front-end” processing to perform part of a compression algorithm when acquiring an image. In particular, the image sensor is configured to provide an output that is proportional to transformation coefficients used by the compression algorithm directly as part of its raw output. The transformation coefficients may be whole coefficients or partial coefficients.

According to embodiments of the present teaching, the image sensor includes a sensor array that implements “front end” processing. The sensor array includes sensors with varying sensitivities or gains in order transform light striking the image sensor, which allows the sensors to generate data that represents transformation coefficients or partial coefficients of a compression algorithm.

Particularly, each sensor of the image sensor, for example each physical pixel, is subdivided into sub-divisions, e.g. sub-pixels. The number of sub-divisions corresponds to the number of transformation coefficients or partial coefficients used by the compression algorithm. Each sub-divisions has a sensitivity or gain related to transformation coefficient or partial coefficient of that sub-division.

To determine the coefficients or partial coefficients, the contribution of each sub-division for a block of sensors is summed. For example, corresponding pixel sub-divisions in different pixels sensors of an 8×8 pixel block are summed. The summed contribution of each sub-division would be equal to the transform coefficient or partial coefficient. As such, the data captured by the image sensor would represent data for a compressed image.

In addition, in order to simplify the image sensor, a reduced or compressed number of transformation coefficients or partial coefficients (such as 20) may be used.

Additionally, according to other embodiments of the present teaching each sensor of the image sensor is subdivided into sub-divisions or sub-pixels. Each sub-division has a junction area related to a coefficient or partial coefficient in a transformation algorithm. Since each sub-division has a junction area that is related to a coefficient or partial coefficient in a transformation algorithm, the summed contribution of each sub-division would be equal to the transformation coefficient or partial coefficient. As such, the raw data captured by the image sensor would represent the transformed image.

In addition, in order to simplify the image sensor, a reduced or compressed number of transformation coefficients or partial coefficients (such as 20) may be used. Sub-divisions across different divisions, but corresponding to the same transformation coefficient or partial coefficient are connected in parallel to provide an output.

By using “front-end” processing, embodiments of the present teaching can be implemented using less power, less memory, reduced physical size, and less bandwidth for transmitting the images. In addition, such “front-end” processing may significantly reduce or even eliminate acquisition delays of an image.

Reference will now be made in detail to the present exemplary embodiments of the present teaching, examples of which are illustrated in the accompanying drawings. Wherever possible, the same reference numbers will be used throughout the drawings to refer to the same or like parts.

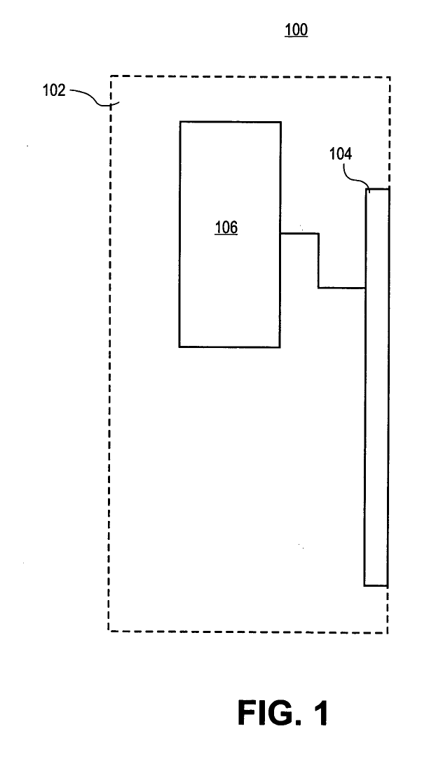

FIG. 1 illustrates an image sensor 100 consistent with embodiments of the present teaching. Image sensor 100 includes an imaging unit 102. It should be readily apparent to those of ordinary skill in the art that image sensor 100 illustrated in FIG. 1 represents a generalized schematic illustration and that other components may be added or existing components may be removed or modified.

Imaging unit 102 may be any type of image detecting device capable of capturing light and converting the captured light into any electrical signal. As illustrated in FIG. 1, imaging unit 102 may include a sensor array 104 and processing device 106. Imaging unit 102 captures light and stores the captured light as data representing an object. Light strikes sensor array 104 producing a signal. Sensor array 104 may be a set of sensors, such as a set of pixel sensors, for capturing different sections of light. For example, sensor array 104 may be an array of semiconductor light sensor elements, such as photodiodes.

Processing device 106 receives a signal from sensor array 104 and performs processing on the signal from sensor array 104. Processing device 106 may also store the signal. Processing device 106 may be any hardware, firmware, software or combination thereof capable of receiving a signal from sensor array 104 and processing the signal.

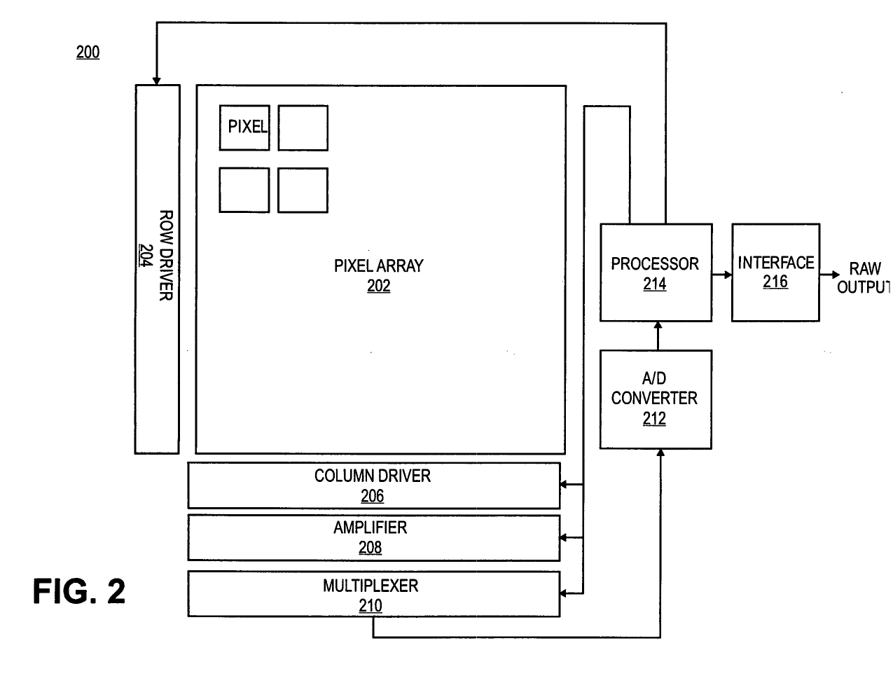

FIG. 2 illustrates an exemplary imaging unit 200 that is in accordance with embodiments of the present teaching. For example, imaging unit 200 may be used as imaging unit 102 in image sensor 100. It should be readily apparent to those of ordinary skill in the art that imaging unit 200 illustrated in FIG. 2 represents a generalized schematic illustration and that other components may be added or existing components may be removed or modified.

As shown in FIG. 2, imaging unit 200 may comprise a pixel array 202, a number of row drivers 204, a number of column drivers 206, a number of amplifiers 208, a multiplexer 210, an analog to digital converter (ADC) 212, a processor 214, and an interface circuit 216. These components may be implemented using hardware, firmware, software, or combination thereof that are known to those skilled in the art and will now be further described.

Pixel array 202 provides an array of sensors that collects photons of light (from an object or scene) that are to be recorded in an image. In general, pixel array 202 is divided into elements, i.e., pixels that make up the recorded image. Typically, pixel array 202 is a two-dimensional array made up of rows and columns of pixels that comprise one or more photosensitive detectors (not shown). The detectors may be complementary metal oxide semiconductor devices or charge coupled devices, which are both known to those skilled in the art.

Because the detectors in each pixel merely produce a charge that is proportional to the amount of light that strikes them, pixel array 202 may comprise one or more additional layers. For example, if imaging unit 200 is intended to provide color images, then pixel array 202 may comprise a color filter that overlays the sensors. Known color filters may employ patterns of red, green, and blue colors, such as a Bayer pattern. Other known color filters may employ other colors, such as cyan, magenta, and yellow. One skilled in the art will realize that any of these types of color filters or other color filters may be implemented in the embodiments of the present teaching.

Row driver 204 comprises the circuitry and other related hardware for driving one or more rows of pixels in pixel array 202. Column driver 206 comprises the circuitry and other related hardware for driving one or more columns of pixels in pixel array 202. The various parts used for row driver 204 and column driver 206 are known to those skilled in the art. One skilled in the art will realize that any hardware, firmware, software, or combination thereof may be utilized.

Amplifier 208 comprises the circuitry and other related hardware for amplifying the output of pixel array 202 to an appropriate voltage level. The components and hardware used for amplifier 208 are known to those skilled in the art. One skilled in the art will realize that any hardware, firmware, software, or combination thereof capable of amplifying an electrical signal may be utilized.

Multiplexer 210 provides circuitry selecting various portions, e.g., columns, of pixel array 202 and, in some embodiments, circuitry for measuring the output of pixel array 202. For example, multiplexer 210 may connect in parallel sub-divisions on different pixels that correspond to the same transformation coefficient or partial coefficient. Accordingly, the output of multiplexer 210 will be proportional to the transformation coefficients used for creating a JPEG image. Such circuitry is known to those skilled in the art. One skilled in the art will realize that any hardware, firmware, software, or combination thereof capable of multiplexing an electrical signal may be utilized.

ADC 212 comprises the hardware and software for converting the analog output of pixel array 202 into digital form. Such hardware and software are known to those skilled in the art. One skilled in the art will realize that any hardware, firmware, software, or combination thereof capable of converting an analog signal to a digital signal may be utilized.

Processor 214 comprises the hardware, firmware, software, or combination thereof for controlling the operation of image sensor 202. Processor 214 may be implemented using known circuitry and/or components. For example, processor 214 may be configured (or programmed) to provide the raw output of pixel array 202. In some embodiments, the raw output of pixel array 202 provides an image in compressed form, such as in the form of JPEG transformation coefficients.

Processor 214 may also provide other data or metadata. For example, processor 214 may provide metadata for de-mosaicing color information from pixel array 202, white balance data, colorimetric interpretation data, gamma correction data, and noise reduction data. Such metadata is known to those skilled in the art.

Furthermore, processor 214 may provide another resource for further compression of the data from imaging unit 200. For example, processor 214 may be configured to perform Huffman coding, run-length encoding, and zig-zag scanning.

Interface circuit 216 comprises the hardware for interfacing image sensor 100 to another device, such as a memory, or communications bus. Interface circuit 216 may be implemented using known components of hardware and/or communications standards. One skilled in the art will realize that any hardware, firmware, software, or combination thereof capable of interfacing with other devices may be utilized.

Returning to FIG. 1, sensor array 104 captures light and produces a signal that represents compressed or transformed data. Sensor array 104 achieves this by performing “front-end” processing on light striking sensor array 104. Sensor array 104 transforms light striking sensor array 104 such that light captured by sensor array 104 would represent data of a compressed image.

To transform the light, sensor array 104 may have different sensitivities or gains for the different sub-divisions of divisions, such as sensor, of sensor array 104. The sensitivities may be related to a coefficient or partial coefficient of an image transform or compression algorithm. For example, the transform or compression algorithm may be JPEG or MPEG.

As mentioned above, sensor array 104 may be composed of multiple divisions, for example pixel sensors. Each division of sensor array 104 may be configured to alter light striking sensor array 104. Each division of sensor array 104 may be further divided into sub-divisions. Sub-divisions of sensor array 104 may be physical divisions of sensor array 104, such as photodiode silicon sub-divisions. Each sub-division of an individual sensor in sensor array 104 represents a coefficient or partial coefficient of a compression or transform algorithm.

Each sub-division of an individual sensor in sensor array 104 transforms the light illuminating sensor array 104 into a data representing a coefficient or partial coefficient of the compression or transform algorithm. As such, sensor array 104 generates data that represents a compressed or transformed image. Processing device 106 then records the data without having to perform further processing on the imaging signal.

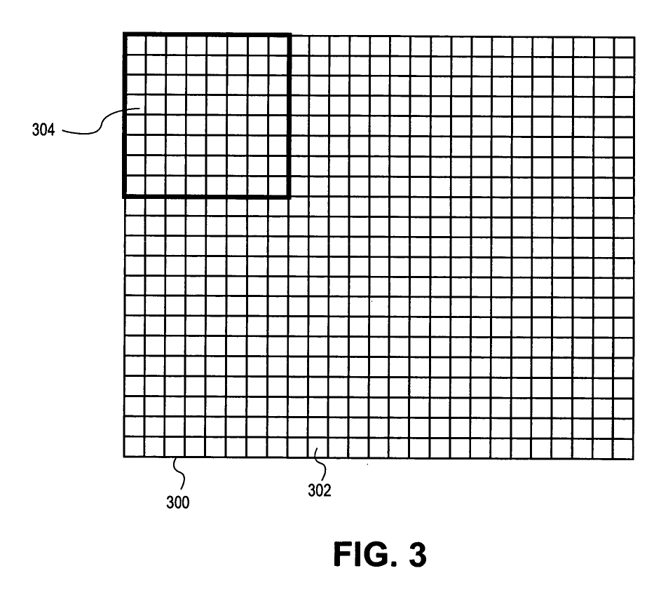

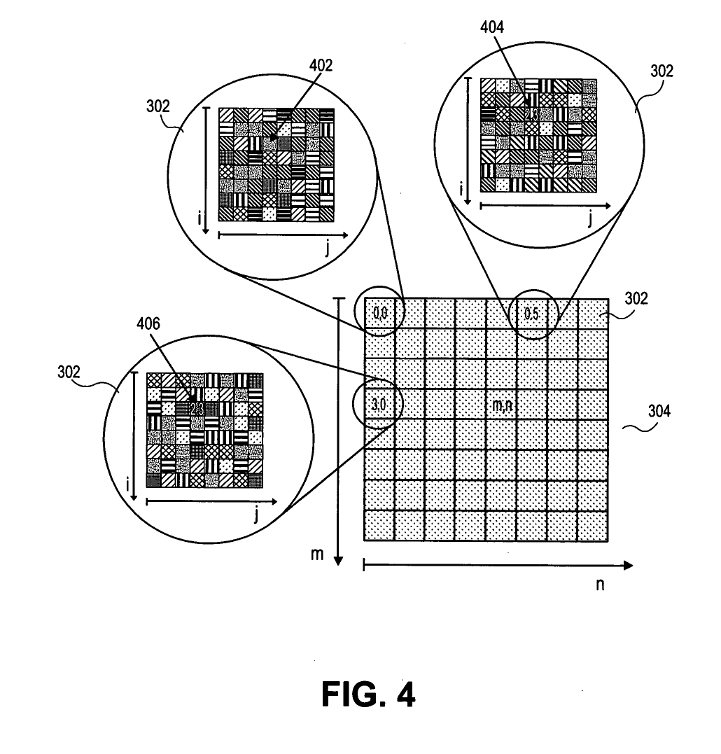

FIGS. 3 and 4 illustrate an exemplary sensor array 300 which may be used in imaging device 100 including an imaging unit 102. Sensor array 300 is configured to be used with transform encoding such as the JPEG compressing algorithm or MPEG. Sensor array 300 alters the light striking imaging array 102 such that the imaging array detects the transformation coefficients of the JPEG or MPEG algorithm. Sensor array 300 alters the light striking imaging array 102 by varying the sensitivity or gain of sensors in sensor array 300. It should be readily apparent to those of ordinary skill in the art that sensor array 300 illustrated in FIGS. 3 and 4 represents generalized schematic illustrations and that other components may be added or existing components may be removed or modified.

The JPEG algorithm is designed to compress either color or grey-scale digital images. Conceptually, JPEG compresses a digital image based on a mathematical tool known as the DCT and empirical adjustments to account for the characteristics of human vision.

The basic DCT can be expressed by the formula:

$$D ( i , j ) = \frac{2}{\sqrt{MN}} C ( i ) C ( j ) {\sum }_{m = 0}^{m = M - 1} {\sum }_{n = 0}^{n = N - 1} p ( m , n ) cos [ \frac{( 2 m + 1 ) i π}{2 M} ] cos [ \frac{( 2 n + 1 ) j π}{2 N} ]$$

where C(i) and C(j) coefficients are:

C(k)=1/\sqrt{2} (for k=0), or =1 (for k>0); and

where p(m,n) represents the pixel values, either intensity or color.

JPEG applies the DCT to an elementary image area (called an “image block”) that are 8 pixels wide and 8 lines high. This causes the basic DCT expression to simplify to:

$$D ( i , j ) = \frac{1}{4} C ( i ) C ( j ) {\sum }_{m = 0}^{m = 7} {\sum }_{n = o}^{n = 7} p ( m , n ) cos [ \frac{( 2 m + 1 ) i π}{16} ] cos [ \frac{( 2 n + 1 ) j π}{16} ]$$

Therefore, in essence, JPEG uses the DCT to calculate the amplitude of spatial sinusoids that, when superimposed, can be used to recreate the original image.

In order to compress the data for an image, JPEG also combines a set of empirical adjustments to the DCT. The empirical adjustments have been developed through experimentation and may be expressed as a matrix of parameters that synthesizes or models what a human vision actually sees and what it discards. Through research, it was determined that a loss of some visual information in some frequency ranges is more acceptable than others. In general, human eyes are more sensitive to low spatial frequencies than to high spatial frequencies. As a result, a family of quantization matrices Q was developed. In a Q matrix, the bigger an element, the less sensitive the human eye is to that combination of horizontal and vertical spatial frequencies. In JPEG, quantization matrices are used to reduce the weight of the spatial frequency components of the DCT processed data, i.e., to model human eye behavior. The quantization matrix Q₅₀ represents the best known compromise between image quality and compression ratio and is presented below.

$${Q}_{50} = [ \begin{matrix}16 & 11 & 10 & 16 & 24 & 40 & 51 & 61 \\ 12 & 12 & 14 & 19 & 26 & 58 & 60 & 55 \\ 14 & 13 & 16 & 24 & 40 & 57 & 69 & 56 \\ 14 & 17 & 22 & 29 & 51 & 87 & 80 & 62 \\ 18 & 22 & 37 & 56 & 68 & 109 & 103 & 77 \\ 24 & 35 & 55 & 64 & 81 & 104 & 113 & 92 \\ 49 & 64 & 78 & 87 & 103 & 121 & 120 & 101 \\ 72 & 92 & 95 & 98 & 112 & 100 & 103 & 99\end{matrix} ]$$

For higher compression ratios, poorer image quality, the Q₅₀ matrix can be multiplied by a scalar larger than 1 and clip all results to a maximum value of 255. For better quality images, but less compression, the Q₅₀ matrix can be multiplied by a scalar less than 1.

Therefore, the JPEG algorithm can be expressed as the following equation:

$$K ( i , j ) = \frac{1}{4} \frac{C ( i ) C ( j )}{Q ( i , j )} {\sum }_{m = 0}^{m = 7} {\sum }_{n = 0}^{n = 7} p ( m , n ) cos [ \frac{( 2 m + 1 ) i π}{16} ] cos [ \frac{( 2 n + 1 ) j π}{16} ]$$

Of note, the application of the quantization matrix with the DCT essentially eliminates many of the frequency components of the DCT alone. The example below illustrates this phenomenon.

For clarity of presentation, the example is limited to a single 8×8 image block from a stock image. For example, suppose the image array I for a single image block is:

$$I = [ \begin{matrix}170 & 153 & 153 & 153 & 160 & 160 & 153 & 134 \\ 170 & 153 & 153 & 160 & 160 & 160 & 153 & 134 \\ 170 & 110 & 153 & 160 & 160 & 153 & 153 & 134 \\ 160 & 110 & 134 & 165 & 165 & 153 & 134 & 110 \\ 160 & 134 & 134 & 165 & 160 & 134 & 134 & 110 \\ 165 & 134 & 134 & 160 & 223 & 134 & 110 & 134 \\ 165 & 134 & 160 & 196 & 223 & 223 & 110 & 134 \\ 165 & 160 & 196 & 223 & 223 & 254 & 198 & 160\end{matrix} ]$$

Initially, it is noted that all values in the I matrix are positive. Therefore, before continuing, the apparent DC bias in the image can be removed by subtracting a value, such as 128, from the matrix I. A new matrix I′ results and is provided below.

$${I}^{′} = [ \begin{matrix}42 & 25 & 25 & 25 & 32 & 32 & 25 & 6 \\ 42 & 25 & 25 & 32 & 32 & 32 & 25 & 6 \\ 42 & - 18 & 25 & 32 & 32 & 25 & 25 & 6 \\ 32 & - 18 & 6 & 37 & 37 & 25 & 6 & - 18 \\ 32 & 6 & 6 & 37 & 32 & 6 & 6 & - 18 \\ 37 & 6 & 6 & 32 & 95 & 6 & - 18 & 6 \\ 37 & 6 & 32 & 68 & 95 & 95 & - 18 & 6 \\ 37 & 32 & 68 & 95 & 95 & 126 & 70 & 32\end{matrix} ]$$

From matrix algebra, the application of the DCT to the image array I is equivalent to multiplying the DCT matrix T by the matrix I. The result may then be multiplied with the transpose of T. From the DCT definition, the elements of the T matrix can be calculated by the equation:

$$T ( i , j ) = \sqrt{\frac{2}{M}} C ( i ) cos [ \frac{( 2 j + 1 ) i π}{2 M} ]$$

where i and j are row and column numbers from 0 to 7. For convenience, the T matrix is presented below.

$$\begin{matrix}T = \\ [ \begin{matrix}0.3536 & 0.3536 & 0.3536 & 0.3536 & 0.3536 & 0.3536 & 0.3536 & 0.3536 \\ 0.4904 & 0.4157 & 0.2728 & 0.0975 & - 0.0975 & - 0.2778 & - 0.4157 & - 0.4904 \\ 0.4619 & 0.1913 & - 0.1913 & - 0.4619 & - 0.4619 & - 0.1913 & 0.1913 & 0.4619 \\ 0.4157 & - 0.0975 & - 0.4904 & - 0.2778 & 0.2778 & 0.4904 & 0.0975 & - 0.4157 \\ 0.3536 & - 0.3536 & - 0.3536 & 0.3536 & 0.3536 & - 0.3536 & - 0.3536 & 0.3536 \\ 0.2778 & - 0.4904 & 0.0975 & 0.4157 & - 0.4157 & - 0.0975 & 0.4904 & - 0.2778 \\ 0.1913 & - 0.4619 & 0.4619 & - 0.1913 & - 0.1913 & 0.4619 & - 0.4619 & 0.1913 \\ 0.0975 & - 0.2778 & 0.4157 & - 0.4904 & 0.4904 & - 0.4157 & 0.2778 & - 0.0975\end{matrix} ]\end{matrix}$$

Continuing now with JPEG, the DCT may be applied to the image matrix I′ by multiplying it with T on the left and the transpose of T on the right. Rounding the result, the following matrix I″ is obtained.

$${I}^{″} = [ \begin{matrix}233 & 21 & - 103 & 78 & 51 & 18 & 25 & 8 \\ - 75 & 19 & 71 & - 21 & - 18 & 26 & - 18 & 12 \\ 104 & - 22 & - 14 & 5 & - 36 & - 11 & 16 & - 18 \\ - 47 & 31 & 10 & - 2 & 27 & - 38 & - 19 & 11 \\ 13 & - 7 & 3 & - 3 & - 29 & 25 & - 12 & - 10 \\ - 16 & - 1 & - 19 & 16 & 16 & - 8 & 25 & - 4 \\ 5 & - 10 & 11 & - 9 & 10 & 2 & - 9 & 24 \\ - 2 & 1 & 3 & - 3 & - 9 & 12 & 9 & - 9\end{matrix} ]$$

In order to consider the empirical data of human vision, each element of the I″ matrix is divided by the corresponding element of a quantization matrix and each result is rounded. For example, if quantization matrix Q₅₀ is used, the result I″ Q₅₀ is expressed below.

$${I}^{″} {Q}_{50} = [ \begin{matrix}15 & 2 & - 10 & 5 & 2 & 0 & 0 & 0 \\ - 6 & 2 & 5 & - 1 & - 1 & 0 & 0 & 0 \\ 7 & - 2 & - 1 & 0 & - 1 & 0 & 0 & 0 \\ - 3 & 2 & 0 & 0 & 1 & 0 & 0 & 0 \\ 1 & 0 & 0 & 0 & 0 & 0 & 0 & 0 \\ - 1 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ]$$

Of note, most of the elements in the result matrix round off to 0. In particular, only 19 of the 64 transformation coefficients are non-zero values. That is, JPEG has eliminated those components that were too small to overcome the human eye's lack of sensitivity to their spatial frequency.

If the quality level is dropped by using a quantization matrix, such as Q₁₀, approximately only 7 nonzero coefficients remain. Likewise, if the quality level is increased by using a quantization matrix, such as Q₉₀, approximately 45 coefficients remain. Therefore, for the most part, the JPEG algorithm utilizes relatively few of the 64 possible transformation coefficients of the DCT.

The number of terms that may bring a non-negligible contribution to the value of K(i,j) depends of the desired fidelity of the image. For example, only 10 to 30 of these 64 terms may bring a non-negligible contribution to the value of K(i,j), with 20 being the most common number. The JPEG algorithm obtains compression replacing the measurement and transmission of 64 pixel values (for each 8×8 tile) with the calculation and transmission of K(i,j) coefficient values. For example, if only 20 of these 64 terms bring a non-negligible contribution to the value of K(i,j), only these 20 coefficient values may be used to represent the image.

As discussed above, at the core of the JPEG algorithm is the division of the DCT coefficients of 8×8 tiles of the image of interest by the experimentally determined quantization values Q(i,j).

Returning to FIG. 3, sensor array 300 may be composed of divisions 302. For example, divisions 302 may be individual pixel sensor of sensor array 300. Sensors 302 in sensor array 300 may be grouped into a sensor block 304. For example, sensors 302 in sensor array 300 may be grouped into 8 by 8 sensor blocks, such as an 8 pixel sensor by 8 pixel sensor block.

As discussed above, at the core of the JPEG algorithm is the division of the DCT coefficients of 8×8 tiles of the image of interest by the experimentally determined quantization values Q(i,j).

The resulting coefficients K(i,j) are given by:

$$K ( i , j ) = \frac{1}{4} \frac{C ( i ) C ( j )}{Q ( i , j )} {\sum }_{m = 0}^{m = 7} {\sum }_{n = 0}^{n = 7} p ( m , n ) cos \frac{( 2 m + 1 ) i π}{16} cos \frac{( 2 n + 1 ) j π}{16}$$

Where:

p(m,n) is the pixel illumination at the position m,n (within the 8×8 tile), Q(i,j) measures the eye sensitivity at the spatial frequencies i and j, and C(k) is given by:

$$C ( k ) = \{ \begin{matrix}\frac{1}{\sqrt{2}} & for k = 0 \\ 1 & for k > 0\end{matrix}$$

As stated above, to implement the proper transformation coefficients or partial coefficients, sensors 302 of sensor array 300 may be divided into sub-divisions. Sub-divisions of sensors 302 in sensor array 300 may be physical divisions of sensor array 300, such as sub-pixels of pixel sensors. For example, the sub-divisions of sensors 302 may silicon sub-divisions of sensor array 300. To alter transform striking the sub-divisions of the sensors 302, each sub-division of sensors 302 may have a sensitivity or gain related to a transformation coefficient or partial coefficient in a compression or transformation algorithm.

FIG. 4 illustrates an exemplary sensor block 304 which is composed of an 8×8 group of sensors 302 in sensor array 300. As illustrated in FIG. 4, a sensor 302 may be located at a position m,n in sensor block 304.

As mentioned above, each sensor 302 of sensor array 300 may be sub-divided into sub-divisions. The number of the sub-divisions of each sensor 302 may be equal to the number of JPEG coefficients K(i,j) desired for the compression or transformation. As illustrated in FIG. 4, sensor block 304 may include a group of 8 sensors 302 by 8 sensors 302, 64 sensors total. If the number of JPEG coefficients desired is 64, each sensor 302 may be divided in 64 sub-divisions. For example, the photodiode silicon may be sub-divided into 64 sub-divisions.

In order to alter light detected by each sub-division of sensors 302, each sub-division of sensors 302 may have a sensitivity or gain related to a transformation coefficient or partial coefficient in a compression or transformation algorithm. Accordingly, as illustrated in FIG. 4, each sensor 302 may be divided into sub-divisions, such as sub-divisions 402, 404, and 406. Each sub-division of sensors 302 may be have a gain or sensitivity related to the transformation coefficient or partial coefficient that that sub-division detects. Accordingly, each sub-division of sensors 302 may capture more or less light striking a sub-division of sensor 302 such that each sub-division produces a signal proportional to the corresponding transformation coefficient or partial coefficient.

For the JPEG algorithm, sub-divisions of sensors 302 in sensor array 300, for example sub-divisions 402, 404, and 406, may have a sensitivity or gain depending of location, m,n, in the sensor block 306, and location of the sub-division, i,j, in division 302. The sensitivity or gain of a given sub-division, depending of location, may be proportional to:

$$\frac{C ( i ) C ( j )}{Q ( i , j )} cos \frac{( 2 m + 1 ) i π}{16} cos \frac{( 2 n + 1 ) j π}{16}$$

As such, light striking sensor array 300 may be transformed into a signal that is proportional to the transformation coefficient K(i,j).

The value of a particular transform coefficient, for example K(2,3), may be determined by summing the contribution of all the corresponding sub-divisions of sensors 304 in sensor block 306. For example, coefficient K(2,3) would be given by

$$K ( 2 , 3 ) = \frac{1}{4} \frac{G}{24} {\sum }_{m = 0}^{m = 7} {\sum }_{n = 0}^{n = 7} p ( m , n ) cos \frac{( 2 m + 1 ) 2 π}{16} cos \frac{( 2 n + 1 ) 3 π}{16}$$

where G is a system-wide gain.

In such a case, for example, sub-division 402 would have a sensitivity or gain of

$$\frac{C ( i ) C ( j )}{Q ( i , j )} cos \frac{π}{8} cos \frac{3 π}{16} .$$

Sub-division 404 would have a sensitivity or gain of

$$\frac{C ( i ) C ( j )}{Q ( i , j )} cos \frac{π}{8} cos \frac{33 π}{16} .$$

Sub-division 404 would have a sensitivity or gain of

$$\frac{C ( i ) C ( j )}{Q ( i , j )} cos \frac{7 π}{8} cos \frac{33 π}{16} .$$

Accordingly, the value measured by sensor array 300 for each sub-division i=2 j=3 of sensors 302, all within the 8×8 block, when summed, would be equal to the transform coefficient K(2,3) for 8×8 sensor block 304. In general, the value measured by sensor array 300 for corresponding sub-divisions i,j of sensors 304, all within the 8×8 block, when summed, would be equal to the transform coefficient K(i,j) for 8×8 sensor block 304. As such, corresponding sub-divisions for every sensor 302 in 8×8 sensor block 304 would be summed to obtain every transformation coefficient or partial coefficient for sensor block 304. Thus, the information captured by sensor array 300 would represent a compressed or transformed image without further processing.

FIG. 4 illustrates 64 sub-divisions of sensors 302 which corresponds to 64 transformation coefficients K(i,j). Sensors 302 in sensor array 300 may be divided into smaller number of sub-divisions, such as 20, if only 20 coefficients or partial coefficient may be required. One skilled in the art will realize that sensors 304 in sensor array 300 may be divided into any number of sub-divisions depending on the desired number of transformation coefficients or partial coefficients and the transformation algorithm utilized.

One skilled in the art will also realize that any transformation or compression algorithm may be utilized to determine the number of sub-division of sensors 302 and the sensitivity or gain of sensors 302. For example, the number of sub-division of sensors 302 and the sensitivity or gain may be related to transformation values in the MPEG algorithm.

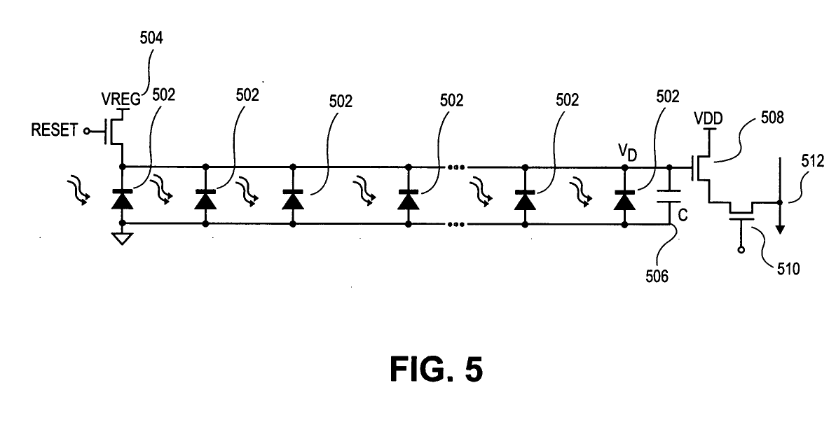

Since the signal generated by each sub-division of sensor array 104 represents a transform coefficient or partial coefficient, all the signals of corresponding sub-divisions of different divisions for a particular 8×8 block must be added. FIG. 5 is a schematic diagram illustrating a measuring circuit for accumulating the measured transform coefficients or partial coefficients for a block of sensors in the sensor array. FIG. 5 illustrates a circuit 500 for the transform coefficient K(2,3). It should be readily apparent to those of ordinary skill in the art that circuit 500 illustrated in FIG. 5 represents a generalized schematic illustration and that other components may be added or existing components may be removed or modified. Further, one skilled in the art will realize that imaging device 100 would have a measuring circuit 500 for each different transform coefficient K(i,j) in a block.

As illustrated in FIG. 5, circuit 500 comprises sensor sub-division elements 502, such as sensor sub-pixel elements. For example, sensor sub-division elements 502 may be photodiodes. Sub-division element may correspond to sub-divisions in sensory array 300. All sensor sub-division element 502 residing on different physical pixels, but corresponding to the same K(i,j) coefficient are coupled in parallel. Sensor sub-division elements 502 are coupled to a transistor 504, a capacitor 506, a transistor 508, and a transistor 510. These allow the selection and reading of signals for sensor sub-division elements 502.

As illustrated in FIG. 5, each sensor sub-division element 502 may correspond to transformation coefficient K(2,3), such as sub-divisions 402, 404, and 406. The signals detected by sensor sub-division elements 502 are output on output line 512. The output of output line 512 is a voltage proportional to the K(2,3) JPEG coefficient.

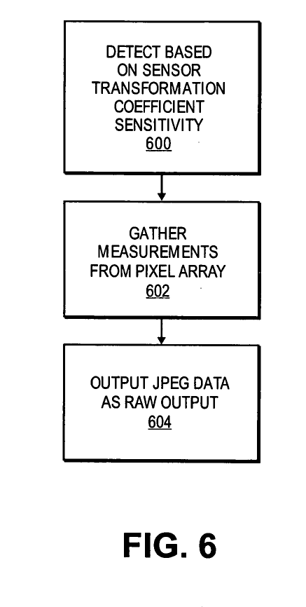

FIG. 6 illustrates an exemplary process flow that is in accordance with an embodiment of the present teaching. For example, the process may be performed on image sensor 100 which includes an imaging unit 200. In stage 600, image sensor 100 is exposed to light. Image sensor 100 is configured as illustrated above such that sub-divisions of sensors 302 of sensor array 300 have sensitivities or gains that are related to coefficients or partial coefficients in a compression or transform algorithm as mentioned above.

Photons may strike respective divisions composed of the sub-divisions elements of pixel array 202 with varying sensitivities or gains. In response, the sub-division elements of pixel array 202 provide a voltage output that is proportional to the amount of light striking that division and the transformation coefficients or partial coefficients as described above. Processing may then flow to stage 602.

In stage 602, multiplexer 210 may gather the measurements from pixel array 102. For example, multiplexer 210 may gather various signals that correspond to the different transformation coefficients or partial coefficients for a pixel block and provide a single, accumulated output that is proportional to the transformation coefficients used by the JPEG algorithm. For example, multiplexer 210 may be coupled to output line 512 various measuring circuits 500 for a pixel block. As such, multiplexer 210 may gather the signals representing all the transformation coefficients or partial coefficients for a pixel block.

In stage 604, ADC 212 converts the measurements from pixel array 202 and converts them into digital data. Processor 214 may then receive the digital data and format it into JPEG data or a JPEG data as the raw output of imaging device 100.

Of course, processor 214 may perform other compression algorithms, such as run length encoding or Huffman coding. Zig-zag scanning may also be employed by processor 214.

As mentioned above, sub-divisions in sensors in sensor array 104 may have sensitivities or gains which convert light striking the image sensor 102 into a signal proportional to transformation coefficients or partial coefficients of a transformation algorithm. According to other embodiments of the invention, the various sensitivities or gains of the sub-divisions may be achieved by varying the junction areas of sub-divisions of sensors in sensor array 104 of image sensor 102, for example sensor array 300. The sub-division junction areas may be related to a coefficient or partial coefficient in a transformation algorithm.

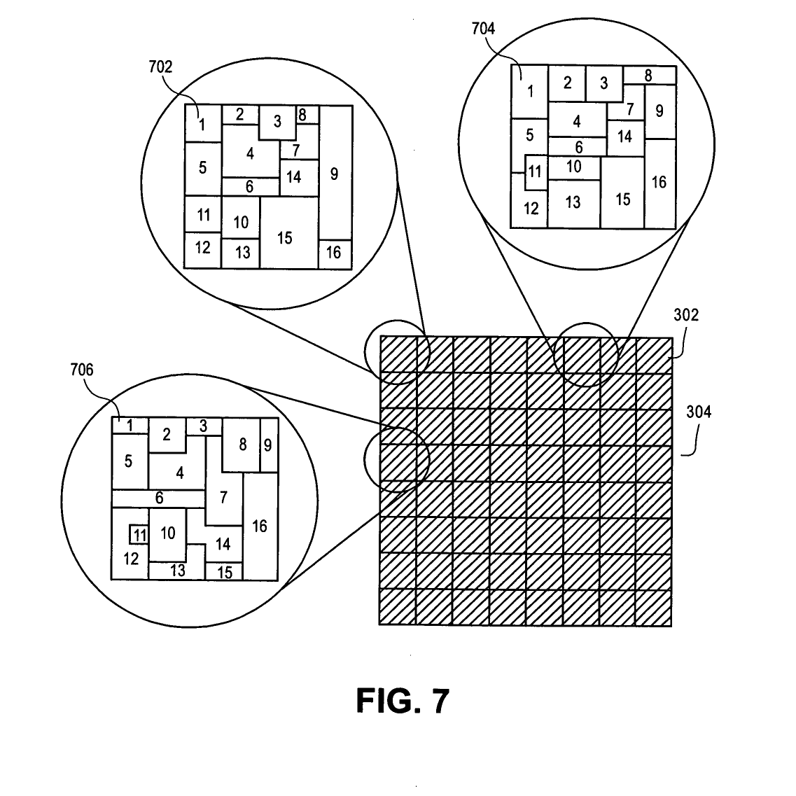

FIG. 7 is a diagram of exemplary sensor block 304 of sensor array 300, for example pixel array 202, consistent with embodiments of the present teachings. It should be readily apparent to those of ordinary skill in the art that FIG. 7 is exemplary and that other components may be added or existing components may be removed or modified.

As illustrated in FIG. 7, each sensor 302 in sensor array 300 comprises sub-divisions, such as sub-divisions 702, 704, and 706, having various junction areas. As shown in FIG. 7, each sub-division may have a junction area depending on its location in sensor 302. Further, each sub-division may have junction areas depending on sensor 302 in which it is located.

As illustrated in FIG. 7, the sub-division junction areas may be related to a transformation coefficient or partial coefficient of a transformation algorithm. As mentioned above in other embodiments, sensors in sensor array 300 may have sensitivities or gains to alter the amount of light captured by sensors in sensor array 300. As such, sub-divisions in sensors in sensor array 300 capture light that is proportional to a transformation coefficient or partial coefficient of a compression or transformation algorithm. According to embodiments illustrated in FIG. 7, the amount of light that strikes sensors 302 may be altered to be proportional to a transformation coefficient or partial coefficient by varying the junction areas of each sub-division of sensors 302. The junction areas of sensors may be increased or decreased in order to alter the amount of light captured by sensors 302.

For example, a sub-division of sensor 302 may only require a sensitivity of 50% or a normal sub-division. According to embodiments illustrated in FIG. 7, to achieve desired sensitivity, the junction area may be decreased so that only 50% of the light is captured. In general, the sub-division (i,j) of pixel (m,n) for a certain JPEG 8×8 pixel block will have a junction area proportional to:

$$\frac{C ( i ) C ( j )}{Q ( i , j )} cos \frac{( 2 m + 1 ) i π}{16} cos \frac{( 2 n + 1 ) j π}{16} .$$

By having varying junction areas, the image captured by image sensor 102 will still be related to the transformation coefficients or partial coefficients of the transformation algorithm.

Since the signal generated by each imaging element of sensor array 104 represent a transformation coefficient or partial coefficient, all the signals of different divisions for a particular sub-division must be added. A measuring circuit, such as measuring circuit 500, may be used to sum the transformation coefficient or partial coefficient from sub-divisions.

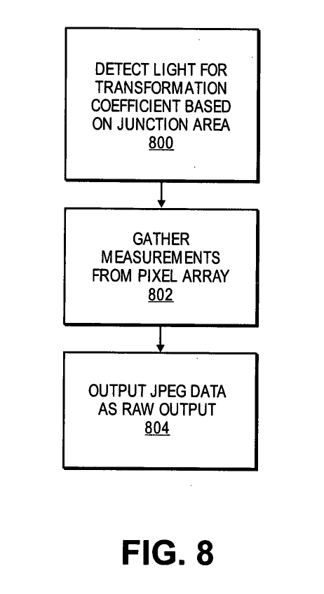

FIG. 8 illustrates an exemplary process flow using the image sensor in which the sub-divisions are configures as illustrated in FIG. 7 that is in accordance with an embodiment of the present teaching. In stage 800, image sensor 102, such as image sensor 200, is exposed to light and pixel array 202 detects the light. As noted above, each sub-division, such as sub-divisions 702, 704, 706 has different junction areas that are related to coefficients or partial coefficients of a transformation algorithm, the JPEG compression algorithm.

The number of sub-divisions implemented in each sensor may be based on a desired quality. For example, in some embodiments, approximately 20 transformation coefficients or partial coefficients may be implemented as various junction areas for each pixel.

As light strikes pixel array 202, photons may strike respective portions of pixels in sub-pixel areas 206. Because the junction areas are related to the transformation coefficients or partial coefficients, the pixels in pixel array 204 provide a voltage output that is proportional to the amount of light striking that pixel and the transformation coefficients or partial coefficients. Processing may then flow to stage 302.

In stage 802, multiplexer 210 may gather the measurements from pixel array 202. For example, multiplexer 210 may gather various signals that correspond to the different transformation coefficients or partial coefficients for a pixel block and provide a single, accumulated output that is proportional to the transformation coefficients or partial coefficients used by the JPEG algorithm. For example, multiplexer 210 may be coupled to output line 512 various measuring circuits 500 for a pixel block. As such, multiplexer 210 may gather the signals representing all the transformation coefficients or partial coefficients for a pixel block.

In stage 804, ADC 112 converts the measurements from pixel array 102 and converts them into digital data. Processor 114 may then receive the digital data and format it into JPEG data or a JPEG data as the raw output of image sensor 100.

Of course, processor 114 may perform other compression algorithms, such as run length encoding or Huffman coding. Zig-zag scanning may also be employed by processor 114.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. An image sensor configured to output transformed data, the image sensor comprising:
a set of pixel sensors, wherein each pixel sensor is divided into sub-divisions having sensitivities based on a transformation algorithm.

2. The image sensor of claim 1, wherein the set of pixel sensors is arranged in pixel blocks.

3. The image sensor of claim 2, further comprising:
measuring circuits coupled to corresponding sub-divisions of different pixels sensors in a pixel block.

4. The image sensor of claim 3, wherein the measuring circuits accumulate a signal from the corresponding sub-divisions.

5. The image sensor of claim 2, wherein the pixel blocks comprise a block of 8 pixel sensors by 8 pixel sensors.

6. The image sensor of claim 2, wherein each pixel sensor of the set of pixel sensors comprises 8 sub-divisions by 8 sub-divisions.

7. The image sensor of claim 2, wherein each pixel sensor of the set of pixel sensors comprises less than 8 sub-divisions by 8 sub-divisions.

8. The image sensor of claim 1, wherein corresponding sub-divisions of the set of pixels sensor have junction areas related to coefficient or partial coefficients of an image transform.

9. The image sensor of claim 8, wherein the coefficients or partial coefficients are terms of product terms in sub-terms of a sum of products transform.

10. The image sensor of claim 9, wherein the sum of products transform is defined by the JPEG compression algorithm.

11. The image sensor of claim 9, wherein the sum of products transform is defined by the MPEG compression algorithm.

12. An imaging device configured to provide transformed image data, the imaging device comprising:
a set of sensors divided into sensor blocks, wherein each sensor is divided into sub-divisions having sensitivities based on a transformation algorithm and
a set of measuring circuits coupled to the set of sensors, wherein each measuring circuit is coupled to corresponding sub-divisions of different sensors in a sensor block.

13. The imaging device of claim 12, wherein the sensor blocks comprise a block of 8 sensors by 8 sensors.

14. The imaging device of claim 12, wherein each sensor of the set of sensors comprises 8 sub-divisions by 8 sub-divisions.

15. The imaging device of claim 12, wherein each sensor of the set of sensors comprises less than 8 sub-divisions by 8 sub-divisions.

16. The imaging device of claim 12, wherein corresponding sub-divisions of the set of sensors have junction areas related to coefficients or partial coefficients of an image transform.

17. The imaging device of claim 16, wherein the coefficients or partial coefficients are terms of product terms in sub-terms of a sum of products transform.

18. The imaging device of claim 12, further comprising:
a processor configured to output the transformed image data as a JPEG file.

19. The imaging device of claim 12, further comprising:
a processor configured to output the transformed image data as a MPEG file.

20. A method of providing an image in transformed form, the method comprising:
gathering data from the set of pixel sensors, wherein each pixel sensor is divided into sub-divisions having sensitivities based on a transformation algorithm; and
providing the transformed data as raw output from the sensor array.
